(19) United States
(12) Patent Application Publication
(10) Pub. No.: US 2010/0329490 A1
(43) Pub. Date: Dec. 30, 2010

(54) AUDIO DEVICE AND METHOD OF OPERATION THEREFOR

(75) Inventors: Nicolle Hanneke Van Schijndel, Eindhoven (NL); Julien Laurent Bergere, Louvain (BE); Susanne Van Vegten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/918,507

(22) PCT Filed: Feb. 16, 2009
(86) PCT No.: PCT/IB2009/050627

§ 371 Date: Aug. 20, 2010

(30) Foreign Application Priority Data
Feb. 20, 2008 (EP) 08151674.2

(51) Int. Cl. H04R 25/00

(52) U.S. Cl. 381/314

(57) ABSTRACT

An audio device is arranged to present a plurality of test audio signals to a user where each test audio signal comprises a signal component and a noise component. A user preference processor (109) receives user preference feedback for the test audio signals and generates a personalization parameter for the user in response to the user preference feedback and a noise parameter for the noise component of at least one of the test audio signals. An audio processor (113) then processes an audio signal in response to the personalization parameter and the resulting signal is presented to the user. The invention may allow improved characterization of a user thereby resulting in improved adaptation of the processing and thus an improved personalization of the presented signal. The invention may e.g. be beneficial for hearing aids for hearing impaired users.

### FIELD OF THE INVENTION

The invention relates to an audio device and a method of operation therefor, and in particular, but not exclusively, to user adaptation of audio processing for a hearing aid.

### BACKGROUND OF THE INVENTION

Adaptation of audio systems to individual users has become important in many applications. For example, it has become a common procedure to adapt and customize hearing aids to the specific characteristics of the individual users. Such customization for example includes making casts of the individual user's ears in order to produce in-ear hearing aids having a shape that exactly matches the user's physiognomy.

In recent years, it has furthermore been proposed to customize the loudness of the generated audio signal to the user's hearing loss and/or preference. Specifically, Patent Cooperation Treaty patent publication WO2004/054318 A1 discloses a portable communication device wherein signal processing characteristics may be adapted to provide a customized loudness setting for the individual user.

However, although such loudness compensation may improve the user experience in many scenarios, the effect tends to be relatively limited and the user experience and audio adaptation tends to be suboptimal.

Hence, an improved audio device would be advantageous and in particular a device allowing increased flexibility, improved user customization, improved adaptation to different audio environments, adaptation of a wider variety of characteristics, practical implementation, an improved user experience and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an audio device comprising: means for providing a plurality of test audio signals, each test audio signal comprising a signal component and a noise component; means for presenting the plurality of test audio signals to a user; means for receiving user preference feedback for the plurality of test audio signals; means for generating a personalization parameter for the user in response to the user preference feedback and a noise parameter for the noise component of at least one of the test audio signals; processing means for processing an audio signal in response to the personalization parameter to generate a processed signal; and means for presenting the processed signal to the user.

The invention may allow an improved user experience and/or may allow improved adaptation of an audio signal to user characteristics and/or characteristics of the audio signal and/or the audio environment. In particular, the invention may allow an improved adaptation to specific audio perception user characteristics. For example, a user's audio perception characteristics may be considerably different in different noise scenarios and the audio device according to the invention may allow such noise dependency to be determined and automatically taken into account when adapting the audio processing to the user.

The personalization parameter may reflect a user preference dependent on the noise characteristic. The noise parameter may be an absolute value or a relative value, e.g. reflecting a relationship between the signal component and the noise component (such as a signal-to-noise indication). The noise parameter may reflect a level and/or distribution of noise in one or more of the test audio signals. The personalization parameter may be determined in response to noise characteristics associated with test audio signals preferred by the user over other test audio signals.

The signal component of the test audio signals may specifically be speech signals. The noise component of the test audio signals may e.g. comprise, background noise, white noise, (interfering) speech signals, music, etc. The signal component and noise component may have different spatial characteristics and the personalization parameter may be determined in response to spatial characteristics of a noise component of one or more of the signals.

The audio device may specifically be a hearing aid and the user may be a hearing impaired user. The personalization parameter may accordingly reflect the specific hearing impairment of the hearing impaired user.

One or more of the test audio signals may be generated by selecting a signal component from a set of predetermined signal components, selecting a noise component from a set of predetermined noise components and combining the selected signal component and noise component. The selected signal component and/or the selected noise component may be individually processed prior to the combining. Such processing may e.g. include level adjustment, filtering, spatial processing etc.

The audio signal being processed may for example be a real-time signal from one or more microphones thereby representing the current audio environment.

In accordance with an optional feature of the invention, the personalization parameter is a function of a noise parameter; and the processing means is arranged to: determine a first noise characteristic for the audio signal; determine a value of the personalization parameter in response to the first noise characteristic; and adapt the processing of the audio signal in response to the value of the personalization parameter.

The feature may allow improved performance and/or facilitate implementation. In particular, the feature may allow an improved dynamic adaptation of the audio device to the currently experienced conditions.

The personalization parameter may specifically be a composite personalization parameter comprising a number of different personalization values each of which is associated with a specific noise parameter value. The processing means may determine the noise parameter value being the closest match to a noise parameter value for the audio signal and may accordingly retrieve the associated value of the personalization parameter.

The personalization parameter and/or parameter value may e.g. represent an absolute numeric value (such as a preferred sound level), a relative numeric value (such as a preferred or minimum signal-to-noise ratio) or may e.g. represent more complex user preferences (such as a distortion versus noise-suppression trade-off as a function of noise level). Thus, the value of the personalization parameter need not be a numeric value but can e.g. be a function of one or more variables or an indication of a preferred processing characteristic or algorithm.

In accordance with an optional feature of the invention, the personalization parameter comprises an indication of a signal to noise relationship preference.

The feature may allow improved performance and may in particular allow improved adaptation of the presented signal to the user's specific characteristics and optionally characteristics of the audio signal. The signal to noise relationship may for example be a signal-to-noise ratio.

In accordance with an optional feature of the invention, the signal to noise relationship preference comprises an indication of a required signal to noise relationship for acceptable speech intelligibility for the user.

The feature may allow improved performance and may in particular allow improved adaptation of the presented signal to the user's specific characteristics and optionally characteristics of the audio signal. The noise relationship preference may for example represent a signal-to-noise ratio indicated by the user to be the lowest level at which the user can understand speech. The acceptable speech intelligibility for the user may thus be assessed by the user and may be reflected in the user preference feedback.

In accordance with an optional feature of the invention, the personalization parameter is dependent on a noise distribution.

The feature may allow improved performance and may in particular allow improved adaptation of the presented signal to the user's specific characteristics and optionally characteristics of the audio signal. The noise distribution may be a spatial distribution and/or may be a distribution in the time and/or frequency domain.

In accordance with an optional feature of the invention, the personalization parameter comprises a signal distortion preference indication.

The feature may allow improved performance and may in particular allow improved adaptation of the presented signal to the user's specific characteristics and optionally characteristics of the audio signal. The distortion preference indication may for example indicate a maximum acceptable distortion and/or a distortion level which is considered imperceptible or insignificant by the user. The distortion may represent a measure of the difference between the signal component of the processed audio signal and the audio signal prior to this processing.

In accordance with an optional feature of the invention, the personalization parameter comprises a speech intelligibility parameter preference indication.

The feature may allow improved performance and may in particular allow improved adaptation of the presented signal to the user's specific characteristics and optionally characteristics of the audio signal. The speech intelligibility parameter may for example be a parameter or setting of a speech enhancement algorithm. The speech enhancement algorithm may improve the intelligibility of speech at the expense of increased isolation. For example, speech intelligibility may be increased by reducing the level of interfering sounds.

In accordance with an optional feature of the invention, the personalization parameter comprises a signal distortion and noise suppression parameter trade-off preference indication.

The feature may allow improved performance and may in particular allow improved adaptation of the presented signal to the user's specific characteristics and optionally characteristics of the audio signal. In particular, it may allow an automated adaptation of the noise and audio quality trade-off to suit the specific user.

In accordance with an optional feature of the invention, the personalization parameter comprises a speech intelligibility and audio beamwidth trade-off preference indication.

The feature may allow improved performance and may in particular allow improved adaptation of the presented signal to the user's specific characteristics and optionally characteristics of the audio signal. In particular, it may allow an automated adaptation of the trade-off between isolating a desired speaker and providing ambient audio to suit the specific user.

In accordance with an optional feature of the invention, the processing means is arranged to adapt an equalization of the audio signal in response to the personalization parameter.

The feature may allow improved performance and may in particular allow improved adaptation of the presented signal to the user's specific characteristics and optionally characteristics of the audio signal. In many embodiments, it may provide an improved user experience and may e.g. improve speech perception by a hearing impaired user.

According to an optional feature of the invention the processing means is arranged to adapt a compression of the audio signal in response to the personalization parameter.

The feature may allow improved performance and may in particular allow improved adaptation of the presented signal to the user's specific characteristics and optionally characteristics of the audio signal. In many embodiments, it may provide an improved user experience and may e.g. improve speech perception by a hearing impaired user.

In accordance with an optional feature of the invention, the processing means is arranged to adapt a speech enhancement processing of the audio signal in response to the personalization parameter.

The feature may allow improved performance and may in particular allow improved adaptation of the presented signal to the user's specific characteristics and optionally characteristics of the audio signal.

In accordance with an optional feature of the invention, the processing means is arranged to adapt an audio beam forming for the audio signal in response to the personalization parameter.

The feature may allow improved performance and may in particular allow improved adaptation of the presented signal to the user's specific characteristics and optionally characteristics of the audio signal. In many embodiments, it may provide an improved user experience and may e.g. improve speech perception by a hearing impaired user. The feature may e.g. allow the trade-off between the perception of a desired signal relative to the perception of the background audio environment to be optimized for the specific preferences of the individual user.

In accordance with an optional feature of the invention, the processing means is arranged to adapt a noise suppression processing of the audio signal in response to the personalization parameter.

The feature may allow improved performance and may in particular allow improved adaptation of the presented signal to the user's specific characteristics and optionally characteristics of the audio signal. In many embodiments, it may provide an improved user experience and may e.g. improve speech perception by a hearing impaired user.

In accordance with an optional feature of the invention, the test audio signals comprise spatial binaural audio signals.

The feature may allow improved performance and may in particular allow improved adaptation of the presented signal to the user's specific characteristics and optionally characteristics of the audio signal. In particular, the feature may allow an improved determination of individual user characteristics which more closely represents the user's audio perception. For example, the approach may allow characteristics of the user's spatial filtering ability to be determined while using headphones (including a binaural hearing aid) thereby allowing improved adaptation of the audio device.

In accordance with an optional feature of the invention, the test audio signals comprise at least one of audio signals comprising spoken sentences and audio signals comprising spoken number sequences.

The feature may allow improved performance and may in particular allow improved adaptation of the presented signal to the user's specific characteristics and optionally characteristics of the audio signal. In particular, the feature may allow an improved determination of individual user characteristics which more closely represents the user's audio perception.

According to another aspect of the invention there is provided a method of operation for an audio device, the method comprising: providing a plurality of test audio signals, each test audio signal comprising a signal component and a noise component; presenting the plurality of test audio signals to a user; receiving user preference feedback for the plurality of test audio signals; generating a personalization parameter for the user in response to the user preference feedback and a noise parameter for the noise component of at least one of the test audio signals; processing an audio signal in response to the personalization parameter to generate a processed signal; and presenting the processed signal to the user.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of an audio device in accordance with some embodiments of the invention;

FIG. 2 illustrates an example of a method of operation for an audio device in accordance with some embodiments of the invention;

FIG. 3 illustrates an example of functionality for generating test signals in accordance with some embodiments of the invention; and

FIG. 4 illustrates an example of a method of operation for an audio device in accordance with some embodiments of the invention.

### DETAILED DESCRIPTION OF THE EMBODIMENTS

The following description focuses on embodiments of the invention applicable to personalization of a hearing aid. However, it will be appreciated that the invention is not limited to this application but may be applied to many other audio devices including for example personal or portable communication devices, such as mobile phones. In the described example, a speech audio signal is processed based on user feedback received for speech test signals. However, it will be appreciated that in other embodiments, other types of audio signals may be processed and/or used as test signals.

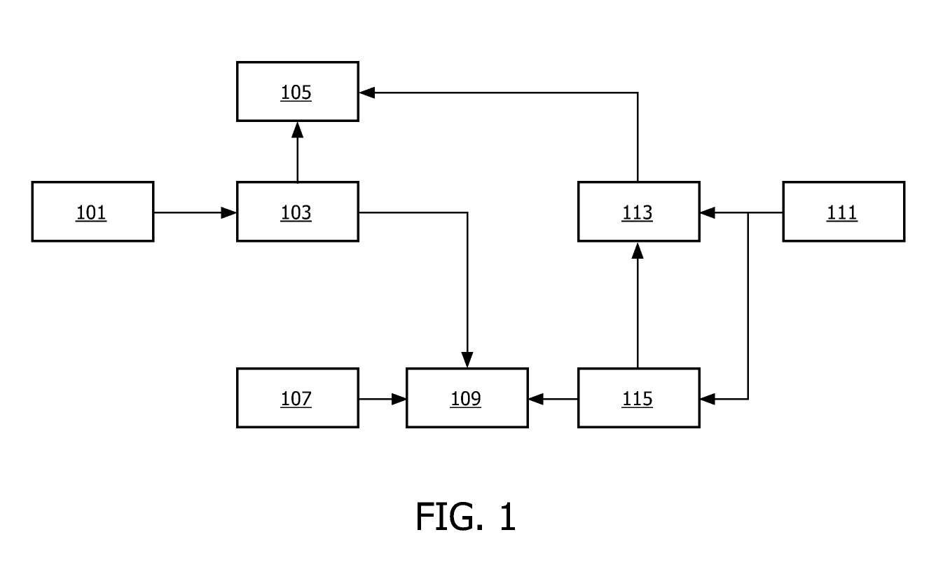

FIG. 1 illustrates an example of an audio device in accordance with some embodiments of the invention. In the specific example, the audio device is a hearing device for a hearing impaired user.

The hearing device of FIG. 1 comprises functionality for presenting an audio signal to a user. Specifically, the signal picked up by a microphone can be processed and output to the user via an in-ear headphone. The processing of the signal can furthermore be personalized to match the specific user's characteristics and preferences. As such, the hearing aid comprises functionality for presenting various test signals to the user and receiving preference feedback. In response to this preference feedback, a personalization parameter is determined and the processing of the microphone signal is adapted in response to this personalization parameter.

Furthermore, the personalization of the processing is dependent on the noise characteristics of the signal and the apparatus comprises functionality for determining personalization parameters which are noise dependent. Specifically, the user is presented with a variety of different test signals which not only represents various desired signals but also represents various noise scenarios. Thus, the stimuli used in the personalization parameter determination can include speech in noise, noise only, tones in noise (with different types of noises) etc. Such an approach may allow a determination of personalization parameters that provide a much better characterization of the user.

In particular, the performance of the ear as well as the brain's ability to analyze the received signals and discriminate between e.g. desired speech and noise can vary substantially between users and in particular between users with hearing difficulties. Furthermore, such variations may be heavily dependent on not only characteristics of the speech signal itself but also on the audio noise environment. The described approach uses test signals that allow such personal characteristics and preferences to be determined. Thus, in comparison to a conventional approach of using clean test signals comprising only the desired signals in silence, the current approach allows a determination of personalization parameters which are much more applicable to must practical environments.

For example, it has been found that the same user parameter preferences can be quite different for different noise scenarios. For instance, preferred volume settings, the trade-off between noise reduction and distortion etc can vary quite substantially. The current system uses a calibration phase to determine a noise dependent personalization parameter and an adaptation phase where the application of this personalization parameter is dependent on the actual experienced noise for the signal being processed.

In particular, after having determined personal settings for given noise situations, the hearing device uses these settings to optimize the audio processing. For example, speech enhancement may be personalized depending on such elements as the level of noise, the type of noise (e.g. voices or music or road noise), the frequency distribution of the noise, the spatial attributes of the noise, etc. The hearing device may for example in dependence on these characteristics and the determined personalization preferences adapt the processing to provide e.g. a personal signal-to-noise ratio needed for good speech intelligibility, a preferred equalization and/or compression of a speech signal in presence of noise, a preferred audio beam forming, and/or a preferred noise suppression used to isolate a desired speech signal in a noise environment, etc.

E.g., the hearing device may determine a current signal-to-noise ratio and only apply noise suppression under certain circumstances which are particularly suitable for the specific user and/or determine the type of noise and only apply noise suppression for certain types of noise etc.

The generation of noise dependent personalization parameters and the combined and integrated adaptation of the processing in response to both the experienced noise and the user's preferences in this particular noise environment result in a significant improvement in performance compared to a system in which the calibration is based on clean speech signals (i.e. where the personalization parameter is not noise dependent). Indeed, the performance improvement is substantial even in comparison to systems wherein independent adaptation of the processing in response to a noise independent personalization parameter and in response to a noise characteristic of the signal being processed is performed. In particular, it has been found that the combination of considering noise in both the calibration and the adaptation stage provides substantial performance gains.

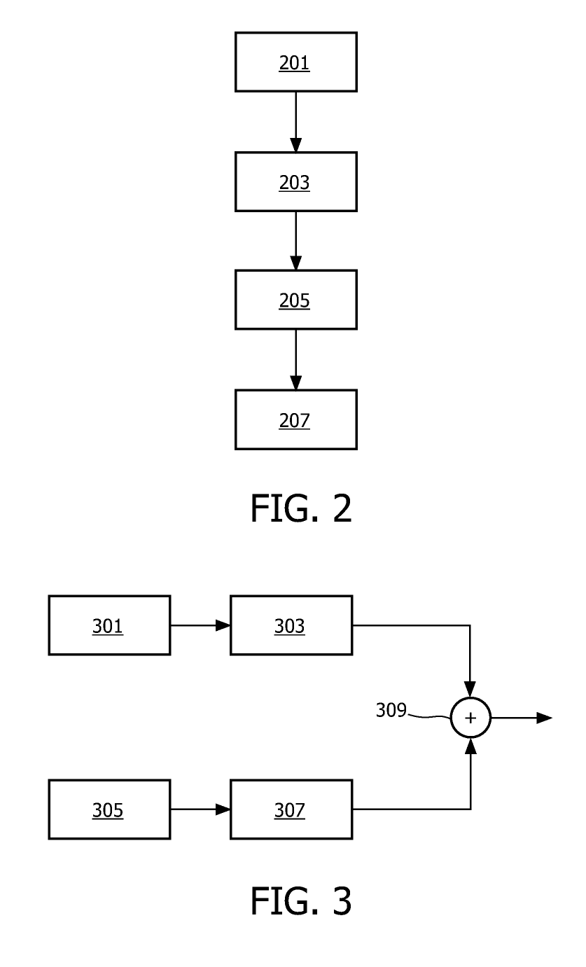

FIG. 2 illustrates an example of a flowchart for a method of operation for the calibration phase of the hearing device of FIG. 1.

The hearing device comprises a test signal source 101 which is coupled to a calibration processor 103 which is further coupled to an audio output 105 which in the specific example comprises an in-ear headphone. The calibration processor 103 is specifically arranged to retrieve test signals from the test signal source 101 and present it to the user via the audio output 105.

Thus, the calibration phase initiates in step 201 wherein a plurality of test audio signals are provided to the calibration processor 103 from the test signal source 101. Each test audio signal comprises both a signal component and a noise component where the signal component corresponds to the desired signal. In the specific example, the signal component is the speech signal, such as for example one or more spoken words, a sequence of numbers or various sentences. The noise component may for example correspond to white noise, non-specific audio background noise, a dominant interfering audio source (such as a second spoken voice etc). In the specific example, the plurality of test audio signals represents a number of different typical use audio environments that the user is likely to encounter during normal operation, such as e.g. when listening to speech in a crowded room.

In some embodiments, the test signal source 101 contains stored versions of the different test signals. Thus the test signal source 101 may comprise a signal store wherein the test signals are stored. For example, a number of test signals may be generated by recording suitable spoken sentences in different audio environments (with different noise characteristics). The resulting signals may be digitized and stored in the signal store of the test signal source 101 for example during manufacturing of the hearing device. Thus, step 201 may simply correspond to the test signals being retrieved from the signal store and fed to the calibration processor 103.

In other embodiments, a more flexible and complex approach may be used. In particular, FIG. 3 illustrates an example of the test signal source 101 in accordance with some embodiments of the invention.

In the example, the test signal source 101 comprises a signal component store 301 wherein a number of signals corresponding to the desired component of the resulting test signal are stored. For example, the signal component store 301 can store a number of speech signals (such as spoken sentences or number sequences), a number of pure tone signals etc.

The signal component store 301 is coupled to a signal component processor 303 which is arranged to process the retrieved signal component signals from the signal component store 301. This processing can include equalizing, filtering, compressing and/or adjusting the volume level of the signal component(s) retrieved from the signal component store 301. Thus, the signal component store 301 provides a set of signal components which can be modified and adapted dynamically by the signal component processor 303 to provide a range of signal components with desired characteristics.

The test signal source 101 furthermore comprises a noise component store 305 wherein a number of signals corresponding to the noise component of the resulting test signals are stored. For example, the noise component store 305 may comprise a stored signal corresponding to white noise, typical ambient noise for a crowded room, a single interfering speaker etc.

The noise component store 305 is coupled to a noise component processor 307 which is arranged to process the retrieved noise component signals from the noise component store 305. This processing can include equalizing, filtering, compressing and/or adjusting the volume level of the noise component(s) retrieved from the noise component store 305. Thus, the noise component store 305 provides a set of noise components which can be modified and adapted dynamically by the noise component processor 307 to provide a range of noise components with desired characteristics.

The signal component processor 303 and the noise component processor 307 are coupled to a combiner 309 which in the specific example is arranged to generate the test signals by adding a signal component from the signal component processor 303 and a noise component from the noise component processor 307.

Thus, the test signal source may generate a set of test signals wherein both the signal component and the noise component have the desired characteristics. The described approach may for example reduce the storage needed for storing calibration signals. For example, only one signal for each spoken sentence may be stored while allowing that different variations of the sentence can be presented to the user (e.g. both a high pass filtered and a low pass filtered version can be generated by the signal component processor 303). Furthermore, the sentence can be presented to the user with different types of noise and furthermore this noise can be adjusted dynamically. In particular, only a single version of each signal component and each noise component need to be stored.

Furthermore, the approach may allow a dynamic adaptation of the generated test signals. For example, based on the received user feedback, test signals may be generated with characteristics particularly suitable for the current user. For example, if the specific user has been found to have a hearing impairment resulting in particular difficulty in understanding speech in the presence of a dominant interfering speaker, a number of test signals having a noise component corresponding to an interfering speaker and with different parameter settings can be generated and presented to the user. This may allow a more accurate determination of the user's specific hearing impairment.

The test signals provided in step 201 thus not only correspond to clean test signals but also include a number of a different noise components thereby allowing the user to be presented with a range of test audio signals that reflect likely use scenarios. This allows the user's specific preferences and characteristics to be more accurately determined as the characteristics typically depend substantially on the characteristics of the whole audio environment rather than just on characteristics of the desired signal.

Step 201 is followed by step 203 wherein the generated test signals are presented to the user. Specifically, the calibration processor 103 sequentially feeds the test signals to the audio output circuitry 105 resulting in the test signals being output via the in-ear headphone.

The hearing device comprises a user feedback processor 107 which is coupled to a user preference processor 109 to which the calibration controller 103 is also coupled. The user feedback processor 107 comprises functionality for interfacing with the user in order to obtain feedback for the presented test signals from the user. Specifically the user feedback processor 107 may comprise functionality for interfacing to a keyboard and display (e.g. via a personal computer) and can accordingly request and receive the appropriate feedback from the user.

As a specific example, the user feedback processor 107 may output a text that test signals will be played. The calibration controller 103 may then proceed to sequentially present two test signals to the user. The user feedback processor 107 may then output text requesting the user to select which of the two signals is preferred. In response, the user enters a response on the keyboard and this response is received by the user feedback processor 107 and fed to the user preference processor 109. This process may be repeated for a plurality of test signals.

It will be appreciated that the user input and output functionality may only be connected during the calibration phase. For example, the user feedback processor 107 may comprise interface functionality for coupling the hearing device to a computer during the calibration process.

Thus, step 203 is followed by step 205 wherein user preference feedback for the plurality of test audio signals is received from the user. Step 205 is followed by step 207 wherein the user preference processor 109 generates a personalization parameter for the user in response to the user preference feedback and noise parameters for the noise component. Thus, the personalization parameter is not only determined in response to the user feedback but is also dependent on the noise characteristics of the test signals. Accordingly, the personalization parameter not only represents a user preference but specifically represents how the user's preference depends on noise.

As an example, the personalization parameter may comprise a preferred setting for a speech enhancement process. For example, high pass filtering of a speech signal may in many embodiments improve intelligibility (understanding) of the speech to a user while at the same time reducing awareness of the environment and/or distorting the signal.

Depending on the user's ability to understand speech, the amount of high pass filtering may accordingly be adjusted such that his specific preferences are met. However, it has been found that the preferred value of high pass filtering depends heavily on the experienced noise conditions. In the example, a personalization parameter that indicates the preferred high pass filtering for different signal-to-noise ratios may be determined. For example, the hearing device may provide a number of test signals with a fixed signal-to-noise ratio and varying high pass filtering to the user and ask the user to select the preferred signal. The corresponding high pass filter settings are then stored as the personalization parameter value for that noise level. The hearing device may then proceed to present test signals for a different noise level and record the preferred high pass filter setting. Hence, a personalized preferred high pass filtering as a function of the signal-to-noise ratio may be determined.

Thus, based on the calibration phase, a lookup table or algorithm describing which processing parameters are preferred in different noise scenarios may be determined.

During normal operation the hearing device is arranged to receive a real-time audio signal from a microphone and to process this before presenting it to the user. The processing is specifically aimed at improving the presented audio signal in order to compensate for a user's hearing impairment. In the example, the processing performed by the hearing device is adapted in response to the personalization parameter in order to provide a signal to the user that is specifically customized for the user. Specifically, the processing may seek to compensate the individual characteristics of the hearing impairment of the specific user.

Accordingly, the hearing device comprises an audio input 111 which comprises (or is coupled to) one or more microphones that capture the current audio environment. The resulting audio signal(s) is fed to an audio processor 113 which is further coupled to the audio output 105. The audio processor 113 processes the input audio signal before feeding it to the audio output 105 for presentation to the user.

The hearing device furthermore comprises an adaptation controller 115 which is coupled to the user preference processor 109, the audio processor 113 and the audio input 111. The audio controller 115 specifically evaluates the currently received real-time input audio signal in order to determine a noise characteristic thereof. It then retrieves the corresponding value of the personalization parameter from the user preference processor 109 and determines the appropriate adaptation of the processing in response thereto. It then controls the audio processor 113 to perform the processing of the microphone signal accordingly. Thus, the processing of the microphone signal(s) performed by the audio processor 113 is dependent on the personalization parameter generated during the calibration phase. The resulting processed signal is presented to the user by the audio output 105.

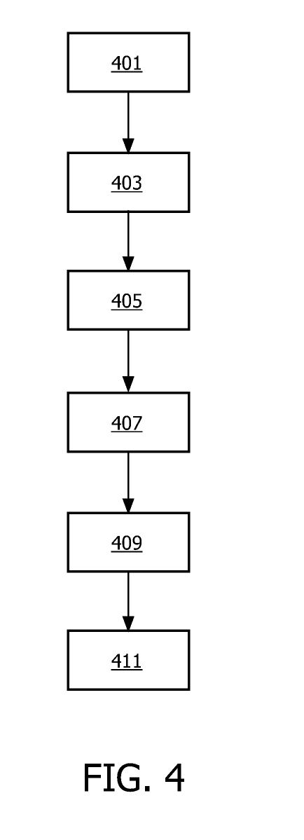

FIG. 4 illustrates an example of the normal operation/adaptation phase of the hearing device of FIG. 1. This phase corresponds to the normal use of the hearing device, i.e. to the use situation wherein a real-time signal is picked up by a microphone, processed by the hearing device and output to a user via the in-ear headphone.

The method initiates in step 401 wherein an input audio signal is generated by the audio input 111 and fed to the audio processor 113 and the adaptation controller 115.

Step 401 is followed by step 403 wherein the adaptation controller 115 proceeds to determine a noise characteristic for the input audio signal. The noise characteristic may specifically be an indication of a noise property of the input audio signal which corresponds to a noise property for which different personalization parameter values are determined.

For example, the noise characteristic may be an absolute or relative indication of the current noise level and/or an indication of the type of noise which is experienced. For example, the noise characteristic may be a value indicating a noise signal level, a signal-to-noise ratio, whether the noise resembles white noise, ambient room noise or single interference noise, a spatial direction of main components of the noise etc.

Step 403 is followed by step 405 wherein the adaptation processor 115 proceeds to determine a value of the personalization parameter in response to the noise characteristic. As an example, the noise parameter may indicate different preferred settings for the processing dependent on a noise characteristic and the adaptation processor 115 may select the setting stored for the noise characteristic value which most closely matches the value that has been determined for the input audio signal. E.g. in the situation where the personalization parameter comprises different high pass filter settings dependent on the signal-to-noise ratio, the adaptation processor 115 may evaluate the signal-to-noise ratio for the input audio signal and retrieve the high pass filter settings stored for the signal-to-noise ratio closest to this.

Step 405 is followed by step 407 wherein the processing of the audio signal is adapted in response to the determined value of the personalization parameter. For example, a high pass filtering of the input audio signal by the audio processor 113 is adapted to the filter settings determined in step 405.

Step 407 is followed by step 409 wherein the input audio signal is processed by the audio processor 113. Specifically the input audio signal may be high pass filtered.

Step 409 is followed by step 411 wherein the resulting signal is fed to the audio output 105 for presentation to the user. Thus the high pass filtered version of the audio signal captured by the microphone is output by the in ear headphones.

After step 411 the method may for example return to step 401 and the process may be iterated. For example, the input audio signal may be segmented into segments of e.g. 20 ms duration and the process described with reference to FIG. 4 may be performed for each individual segment.

The described approach allows an efficient and accurate determination of personal and individual preferences and characteristics which can be used to automatically adapt the processing of a signal in order to generate an output signal that reflects these preferences and characteristics. A substantially improved performance is achieved by considering noise characteristics during both the calibration phase and the operational phase.

It will be appreciated that the personalization parameter may in different embodiments comprise indications of different user preferences and characteristics and that different signal processing may be adapted in different embodiments. In the following some specific examples will be described in more detail.

In some embodiments, the personalization parameter may comprise an indication of a signal to noise relationship preference. In particular, the personalization parameter may comprise an indication of a required signal to noise relationship for acceptable speech intelligibility for the user.

The personalization parameter determination may for example include the calibration processor 103 presenting a number of test signals comprising a spoken sentence and having noise at different noise levels. The user preference feedback may indicate which of these test signals are understandable to the user and which test signals did not allow the speech to be understood. Based on this preference feedback, the user preference processor 109 can determine the minimum required signal-to-noise ratio needed for speech to be intelligible to this user. It has been found that in particular for hearing impaired users this parameter varies widely between users.

In the example, the adaptation processor 115 is arranged to determine a signal-to-noise ratio for the input audio signal. It will be appreciated that a number of different algorithms and techniques for determining a signal-to-noise ratio for an audio signal will be known to the skilled person. The determined signal-to-noise ratio is compared to the minimum required signal-to-noise ratio and the processing of the audio processor 113 is adapted accordingly. For example, if the determined signal-to-noise ratio exceeds the required signal-to-noise ratio, no noise suppression is applied to the audio input signal whereas a noise suppression technique is applied if the determined signal-to-noise ratio is below the required signal-to-noise ratio. The level of noise suppression may furthermore be dependent on the level of the determined signal-to-noise ratio compared to the required signal-to-noise ratio.

It will be appreciated that the noise dependency of the personalization parameter is inherently embedded in the signal-to-noise ratio requirement. In particular, a minimum signal-to-noise ratio requirement corresponds to a minimum signal level requirement which is dependent on the current noise level.

In some embodiments, the personalization parameter may be dependent on a noise distribution. This noise distribution may for example be a distribution in the spatial, time or frequency domain.

For example, the personalization parameter may include an indication of whether the experienced noise is a continuous constant noise, whether it is a periodically repeating noise (e.g. such as from an alarm sound emitted from a lorry when reversing) etc. The processing of the input audio signal may be adapted accordingly, for example by applying a continuous noise suppression algorithm in the presence of continuous noise and a periodic noise suppression algorithm in the presence of a periodically repeating noise signal.

As another example, the personalization parameter may comprise an indication of whether the noise is characterized by having a flat frequency spectrum, being concentrated in a small frequency band, and/or having predominantly low frequency noise or high frequency noise. The processing of the audio input signal may be adapted accordingly, for example by applying a notch filter, high pass filter or a low pass filter depending on the noise characteristics.

As yet another example, the personalization parameter may comprise an indication of the noise level in different angular directions from the hearing device. For example it may indicate whether the noise is predominantly from a single direction corresponding to a single dominant interfering signal, whether it is relatively equally distributed in all directions corresponding to defuse background noise etc. The processing of the audio input signal may be adapted accordingly, for example by selecting an appropriate noise suppression algorithm depending whether the noise corresponds to defuse ambient noise or a single interferer. As a specific example, audio beam forming may be adapted according to the spatial distribution.

Such an approach allows the user's preference and characteristics to be taken into account when adapting the processing of the audio input signal. This may provide a substantial improvement as users (and in particularly hearing impaired users) may have very different sensitivities depending on such distributions. For example, some users may have particular difficulties in certain frequency bands, be particularly insensitive to high frequency or low frequency signals, have reduced sensitivity in some directions (e.g. due to the hearing impairment being worse in one ear than the other) etc. Furthermore, such characteristics can depend heavily on the noise environment itself.

In some embodiments, the personalization parameter may comprise a signal distortion preference indication. For example, the personalization parameter may comprise an indication of a maximum distortion that may be applied to the input signal depending on the background noise level. For example, if the noise level is high, the user may accept a high distortion as this is unlikely to significantly affect the perceived quality or as this may be considered an acceptable price for noise suppression that is sufficiently strong to make the signal intelligible, whereas at a low noise level such distortion may be unacceptable.

In some embodiments, the personalization parameter may comprise a speech intelligibility parameter preference indication. The speech intelligibility parameter may for example be an indication of a preferred setting or a preferred characteristic of a speech enhancement algorithm. As another example, the speech intelligibility parameter may reflect a desired property of the resulting processed audio signal with the property being indicative of the intelligibility of the speech. For example, the speech intelligibility parameter may comprise a desired distribution between high frequency content and low-frequency content in the provided speech.

Thus, the described approach may be used to determine how well the user can understand speech. The calibration phase can include a speech intelligibility test (such as the so-called telephone test or a comparison test asking which test signal is more intelligible) and the results can be used to determine the settings of the processing of the audio input signal. For example, if the user has a severe intelligibility problem, more isolation may be allowed for this person compared to an average user.

In some embodiments, the personalization parameter may comprise a signal distortion and noise suppression parameter trade-off preference indication.

Typically noise suppression algorithms improve the ability to perceive speech in noise by processing signals such that the noise component is reduced. However, such processing typically introduces distortion to the speech signals by degrading the perceived audio quality of the desired speech signal itself. For example, in an environment wherein there is substantial low frequency noise, a simple noise suppression algorithm may consist in high pass filtering the audio signal. However, although such high pass filtering may reduce the noise, it will also distort the desired speech signal thereby degrading the quality thereof.

Thus, in some embodiments, the preferred trade-off between distortion/signal quality and noise suppression for different noise environments is determined during the calibration phase and used to adapt the processing of the input audio signal during normal operation. For example, the user is requested to select between test signals with different trade-offs and the settings corresponding to the preferred trade-off are stored (e.g. the filter characteristics associated with the preferred test signal). During operation, the current noise characteristics are assessed and the filter characteristics associated therewith are retrieved and used by the audio processor 113.

In the example, dependent on the personal characteristics and preferences of the user, audio processing parameters are chosen for joint optimization of noise and distortion characteristics with different weights depending on the current noise characteristics. For example, it may be desirable to introduce noise suppression but as this introduces distortions there is a trade-off between these factors. This trade-off is highly personal and noise dependent and the described approach allows the preferred trade-off to be determined and applied.

In the examples described above, the audio processor 113 may adapt a speech enhancement processing in response to the personalization parameter. E.g., having determined personal settings for given noise situations, the hearing device uses these parameters to provide a personalized optimization of the speech enhancement processing depending on e.g. such elements as the level of the experienced noise, the nature of it (e.g. whether it is voices, music or road noise) the frequency content of it, the spatial attributes of it, etc.

In some embodiments, the audio processor 113 may specifically adapt an equalization of the audio signal in response to the personalization parameter. For example, as previously described, a high pass filtering may be adapted depending on the personalization parameter (e.g. the cut-off frequency, the degree of attenuation etc). It will be appreciated that in other embodiments, more complex equalization may be performed and that e.g. more complex filtering may be applied. For example, a filtering reflecting the user's audio sensitivity as a function of frequency may be performed.

In some embodiments, the audio processor 113 may adapt a compression of the audio signal in response to the personalization parameter. By means of compression, the audio signal is put in the dynamic range of the user, which is the range between the hearing threshold of the user and his uncomfortable loudness level. In other words, the signal is made loud enough to be perceived, but not too loud to be uncomfortable. To be able to do this, the amount of amplification/attenuation depends on the level of the input signal. In addition, compression may be adapted depending on the personalization parameter. For example, the dynamic range of the user may be further restricted based on his personal preferences, which may be different for different frequency ranges and/or different noise signals.

In some embodiments, the audio processor 113 may adapt a noise suppression process for the audio signal in response to the personalization parameter. For example, the degree of noise suppression or the type of noise suppression (such as high-pass filtering, spectral subtraction) may be adapted based on the personalization parameter.

In some embodiments, the audio processor 113 may adapt an audio beam forming for the audio signal in response to the personalization parameter. Audio beam forming has been introduced to e.g. hearing aids in order to improve the user experience. For example, audio processing algorithms have been used to provide an improved signal-to-noise ratio between a desired sound source and an interfering sound source resulting in a clearer and more perceptible signal being provided to the user. In particular, hearing aids have been developed which include more than one microphone with the audio signals of the microphones being dynamically combined to provide a directivity for the microphone arrangement. Such directivity may be achieved by beam forming algorithms.

In some embodiments, the audio input 111 may accordingly comprise a plurality of microphones generating a plurality of microphone signals. For example, the audio input may comprise two omni-directional microphones mounted in an end-fire configuration (mounted along a line towards the front when worn by a user). It will be appreciated that an omni-directional microphone is a microphone for which the sensitivity variation as a function of the angle between a sound source and a reference direction is less than a given value.

The audio processor 113 may accordingly execute a beam forming algorithm which combines the signals from a plurality of microphones to generate an output signal corresponding to a beam formed sensitivity pattern as will be known to the person skilled in the art. An example of a suitable beam forming algorithm is for example described in G. W. Elko, “Superdirectional microphone arrays”, ch. 10, pp. 181-238, in Acoustic Signal Processing for Telecommunications, S. L. Gay and J. Benesty, Eds. Kluwer Academic Publishers, 2000.

In the hearing device of FIG. 1, the beam forming settings are dependent on the personalization parameter. For example, the beam width of the generated audio beam may depend on the personal preferences or characteristics of the user. As a specific example, the adaptation process 115 may provide the audio processor 113 with a desired signal-to-noise requirement. If the current signal-to-noise ratio for the generated audio signal (following beam forming) is substantially above the desired signal-to-noise ratio, the beam width may be increased thereby allowing more ambient noise to be provided to the user. However, if the current signal-to-noise ratio is below the desired signal-to-noise ratio (or e.g. within a predetermined margin thereof), the audio processor 113 may narrow the beam width thereby excluding ambient noise and focusing on the desired signal source.

The approach can for example allow an automatic adaptation of the amount of ambient audio environment noise being provided to the user to the specific preferences and characteristics of this user. E.g., the approach may allow the user to be provided with a signal that represents the entire audio environment unless the specific characteristics of the user necessitates that spatial beam forming is applied in order to isolate the desired signal.

As a specific example, the personalization parameter may comprise a speech intelligibility and audio beamwidth trade-off preference indication. Typically, speech intelligibility can be improved by narrowing the audio beamwidth as this provides improved isolation of the desired signal source (e.g. speaker). However, such narrowing also reduces the amount of ambient sound thereby reducing the awareness of the environment.

It will be appreciated that different calibration signals may be used in different embodiments. In the specific example, at least one of audio signals comprising spoken sentences and audio signals comprising spoken number sequences is used. In contrast to using single word based test signals, this may allow a substantially improved performance. In particular, human speech perception is not just controlled by the inability to differentiate individual words but rather includes the brain analyzing whole sentences. For example, a person is normally able to correctly perceive a sentence even if some individual words are not clearly perceived. By using test signals based a whole sentence structures, the ability of the individual user to perform such coherency processing can also be characterized and accordingly the operation of the hearing device may be adapted accordingly.

In some embodiments, some or all of the test audio signals may be spatial binaural audio signals. Such an approach may be applicable to any situation wherein the test signals are presented to the user using a stereo/binaural headphone arrangement and may in particular be advantageous to situations wherein e.g. a hearing aid comprises a headphone for each ear.

Specifically, for a conventional stereo/binaural headphone arrangement the sound is perceived to be originating from a position inside the users head. This is of course highly artificial and accordingly techniques have been developed for 3D sound source positioning for headphone applications. For example, music playback and sound effects in mobile games can add significant value to the consumer experience when positioned in 3D, effectively creating an ‘out-of-head’ 3D effect.

Thus, techniques have been developed for recording and reproducing binaural audio signals which contain specific directional information to which the human ear is sensitive. Binaural recordings are typically made using two microphones mounted in a dummy human head, so that the recorded sound corresponds to the sound captured by the human ear and includes any influences due to the shape of the head and the ears. Binaural recordings differ from stereo (that is, stereophonic) recordings in that the reproduction of a binaural recording is generally intended for a headset or headphones, whereas a stereo recording is generally made for reproduction by loudspeakers. While a binaural recording allows a reproduction of all spatial information using only two channels, a stereo recording would not provide the same spatial perception. Regular dual channel (stereophonic) or multiple channel (e.g. 5.1) recordings may be transformed into binaural recordings by convolving each regular signal with a set of perceptual transfer functions. Such perceptual transfer functions model the influence of the human head, and possibly other objects, on the signal. A well-known type of spatial perceptual transfer function is the so-called Head-Related Transfer Function (HRTF). An alternative type of spatial perceptual transfer function, which also takes into account reflections caused by the walls, ceiling and floor of a room, is the Binaural Room Impulse Response (BRIR).

In the specific example, these techniques are used to generate spatial test audio signals. For example, the signal component may be processed by an HRTF corresponding to a location directly in front of the user. A noise component corresponding to a single dominant interferer may be processed by an HRTF corresponding to a location at a given angle and the two signal components may be added together to provide a test signal corresponding to a desired audio source directly in front of the user and a dominant interferer at the selected angle. Different test signal may e.g. be generated corresponding to the interferer being at different angles. Based on the user preference values, a personalization parameter indicating the specific user's sensitivity to interference at different angles or the user's acceptance of isolation may accordingly be determined and used to adapt the processing of the audio input signal.

The use of a spatially realistic noise (and potentially speech) signals during calibration may provide a substantially improved user characterization and adaptation leading to improved performance of the hearing device. In particular, spatially realistic noise and speech signals allow the person's ability to apply “the cocktail party” effect (the ability of the brain to spatially discriminate and selectively listen more attentively to signals coming from a given direction) to be evaluated during the calibration phase. Thus, the calibration process will more closely resemble the real usage scenario and audio perception thereby resulting in improved characterization and adaptation.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An audio device comprising:
means (101) for providing a plurality of test audio signals, each test audio signal comprising a signal component and a noise component;
means (103) for presenting the plurality of test audio signals to a user;
means (107) for receiving user preference feedback for the plurality of test audio signals;
means (109) for generating a personalization parameter for the user in response to the user preference feedback and a noise parameter for the noise component of at least one of the test audio signals;
processing means (113) for processing an audio signal in response to the personalization parameter to generate a processed signal; and
means (105) for presenting the processed signal to the user.

2. The audio device of claim 1 wherein the personalization parameter is a function of a noise parameter; and the processing means (113) is arranged to:
determine a first noise characteristic for the audio signal;
determine a value of the personalization parameter in response to the first noise characteristic; and
adapt the processing of the audio signal in response to the value of the personalization parameter.

3. The audio device of claim 1 wherein the personalization parameter comprises an indication of a signal to noise relationship preference.

4. The audio device of claim 3 wherein the signal to noise relationship preference comprises an indication of a required signal to noise relationship for acceptable speech intelligibility for the user.

5. The audio device of claim 1 wherein the personalization parameter is dependent on a noise distribution.

6. The audio device of claim 1 wherein the personalization parameter comprises a signal distortion preference indication.

7. The audio device of claim 1 wherein the personalization parameter comprises a speech intelligibility parameter preference indication.

8. The audio device of claim 1 wherein the personalization parameter comprises a signal distortion and noise suppression parameter trade-off preference indication.

9. The audio device of claim 1 wherein the personalization parameter comprises a speech intelligibility and audio beamwidth trade-off preference indication.

10. The audio device of claim 1 wherein the processing means (113) is arranged to adapt an equalization of the audio signal in response to the personalization parameter.

11. The audio device of claim 1 wherein the processing means (113) is arranged to adapt a compression of the audio signal in response to the personalization parameter.

12. The audio device of claim 1 wherein the processing means (113) is arranged to adapt a speech enhancement processing of the audio signal in response to the personalization parameter.

13. The audio device of claim 1 wherein the processing means (113) is arranged to adapt an audio beam forming for the audio signal in response to the personalization parameter.

14. The audio device of claim 1 wherein the processing means (113) is arranged to adapt a noise suppression processing of the audio signal in response to the personalization parameter.

15. The audio device of claim 1 wherein the test audio signals comprise spatial binaural audio signals.

16. The audio device of claim 1 wherein the test audio signals comprise at least one of audio signals comprising spoken sentences and audio signals comprising spoken number sequences.

17. A method of operation for an audio device, the method comprising:
providing (201) a plurality of test audio signals, each test audio signal comprising a signal component and a noise component;
presenting (203) the plurality of test audio signals to a user;
receiving (205) user preference feedback for the plurality of test audio signals;
generating (207) a personalization parameter for the user in response to the user preference feedback and a noise parameter for the noise component of at least one of the test audio signals;
processing (407, 409) an audio signal in response to the personalization parameter to generate a processed signal; and
presenting (411) the processed signal to the user.
